(19) United States
(12) Patent Application Publication
(10) Pub. No.: US 2005/0008137 A1
(43) Pub. Date: Jan. 13, 2005

(54) Telephone exchange apparatus and telephone exchange system

(76) Inventor: Yoichi Naito, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/855,521

(22) Filed: May 28, 2004

(30) Foreign Application Priority Data
May 30, 2003 (JP) 2003-155470

(51) Int. Cl. H04M 3/42

(52) U.S. Cl. 379/211.02

(57) ABSTRACT

A telephone exchange apparatus includes acquisition circuit selectively acquires schedule information that includes destination information showing the destinations of the users of at least a part of the plurality of telephone terminals for a specific period of time, and forwarding destination information showing a first telephone terminal to receive an incoming call at each of the destinations, memory circuit store degree-of-importance information showing the degree of importance of call forwarding in such a manner that the degree-of-importance information corresponds to caller information showing a telephone terminal at the calling party, and a controller controls the acquisition circuit to acquire the schedule information about the user of a second telephone terminal acting as an incoming call destination, performs incoming call control of the first telephone terminal based on the schedule information and the degree-of-importance information corresponding to the caller information, when incoming call control of the second telephone terminal is impossible.

### CROSS-REFERENCE TO RELATED APPLICATIONS

This application is based upon and claims the benefit of priority from prior Japanese Patent Application No. 2003-155470, filed May 30, 2003, the entire contents of which are incorporated herein by reference.

### BACKGROUND OF THE INVENTION

1. Field of the Invention

This invention relates to, for example, a PBX (Private Branch Exchange) or a key telephone unit. More particularly, this invention relates to a telephone exchange apparatus capable of forwarding a call arriving at a telephone terminal to another telephone terminal and a telephone exchange system which connects the telephone exchange apparatus to each telephone terminal via a communication network.

2. Description of the Related Art

As is commonly known, a telephone exchange apparatus, such as a PBX or a key telephone unit, has various service functions. One of them is an incoming call forwarding function. For example, the incoming call forwarding function enables the user of internal phone A to make a forwarding registration to forward a call arriving at internal phone A to another internal phone B, thereby enabling a terminating call arriving at the user's internal phone A to be forwarded to internal phone B.

In the incoming call forwarding function, since the forwarding destination of a terminating call arriving at internal phone A has been registered in internal phone B beforehand, for example, whenever the user of internal phone A moves from the room where internal phone B is installed to the meeting room where internal phone C is installed, the user has to go to the installation location of internal phone A and make a setting registration to specify internal phone C as an incoming call forwarding destination, which is very inconvenient. This problem becomes more significant as the number of moves per day increases.

To overcome this problem, an exchange system has been proposed which registers schedule information about, for example, user's destinations for a week and the telephone number at which an incoming call is to be received at the destination, thereby forwarding automatically a terminating call arriving at internal phone A to the telephone at the destination shown in the schedule information (Jpn. Pat. Appln. KOKAI Publication No. 2000-115380, Jpn. Pat. Appln. KOKAI Publication No. 5-236127, Jpn. Pat. Appln. KOKAI Publication No. 11-341051).

In the above system, the terminating calls from various callers are forwarded to the telephone terminal at the destination shown in the schedule information under the same condition. Therefore, for example, when terminating calls from special callers and terminating calls from ordinary callers concentrate in the same time zone, some of the terminating calls from ordinary callers might be forwarded first. Accordingly, with the above system, it is difficult to forward incoming calls suitably according to the individual callers.

### BRIEF SUMMARY OF THE INVENTION

It is, accordingly, an object of the present invention to provide a telephone exchange apparatus and a telephone exchange system which enable an incoming call to be forwarded flexibly according to the change of the user's destination without the user's manual operation, thereby improving the user's convenience and making it possible to forward incoming calls by caller suitably and efficiently.

According to an aspect of the present invention, there is provided a telephone exchange apparatus which connects a plurality of telephone terminals and is adapted to connect to at least one network and which is adapted to forward a call arriving at one telephone terminal to another, the telephone exchange apparatus comprising: an acquisition circuit configured to selectively acquires schedule information that includes destination information showing the destinations of the users of at least a part of the plurality of telephone terminals for a specific period of time, and forwarding destination information showing a first telephone terminal to receive an incoming call at each of the destinations; a memory circuit configured to store degree-of-importance information showing the degree of importance of call forwarding in such a manner that the degree-of-importance information corresponds to caller information showing a telephone terminal at the calling party; and a controller which controls the acquisition circuit to acquire the schedule information about the user of a second telephone terminal acting as an incoming call destination, and performs incoming call control of the first telephone terminal based on the schedule information and the degree-of-importance information corresponding to the caller information stored in the memory circuit, when incoming call control of the second telephone terminal is impossible at the time of the generation of an incoming call.

According to another aspect of the present invention, there is provided a telephone exchange system which includes a plurality of telephone terminals connected to a communication network, and an exchange apparatus which houses the plurality of telephone terminals via the communication network and connects the plurality of telephone terminals to cause the telephone terminals to communicate with one another, the exchange apparatus comprising: an acquisition circuit configured to selectively acquire schedule information that includes destination information showing the destinations of the users of at least a part of the plurality of telephone terminals for a specific period of time and forwarding destination information showing a first telephone terminal to receive an incoming call at each of the destinations; a store circuit configured to store degree-of-importance information showing the degree of importance of call forwarding in such a manner that the degree-of-importance information corresponds to caller information showing a telephone terminal at the calling party; and a controller which controls the acquisition circuit to acquire the schedule information about the user of a second telephone terminal acting as an incoming call destination, and performs incoming call control of the first telephone terminal based on the schedule information and the degree-of-importance information corresponding to the caller information stored in the memory circuit, when incoming call control of the second telephone terminal is impossible at the time of the generation of an incoming call.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a diagram showing a configuration of an embodiment of a network telephone system according to the present invention;

FIG. 2 is a block diagram showing a configuration of the main unit according to the present invention;

FIG. 3 is a diagram showing an example of the schedule information by server unit;

FIG. 4 is a diagram showing an example of the stored contents of the caller-to-degree-of-importance correspondence table;

FIG. 5 is a block diagram showing an example of the stored contents of the forwarding-destination-to-degree-of-importance correspondence table;

FIG. 6 is a diagram to help explain an incoming call forwarding operation when the user in the system is in a meeting;

FIG. 7 is a diagram to help explain an incoming call forwarding operation when the user in the system is out; and

FIG. 8 is a flowchart showing the processing of the controller in the main unit.

The accompanying drawings, which are incorporated in and constitute a part of the specification, illustrate presently preferred embodiments of the invention, and together with the general description given above and the detailed description of the preferred embodiments given below, serve to explain the principles of the invention.

### DETAILED DESCRIPTION OF THE INVENTION

Hereinafter, referring to the accompanying drawings, an embodiment of the present invention will be explained in detail.

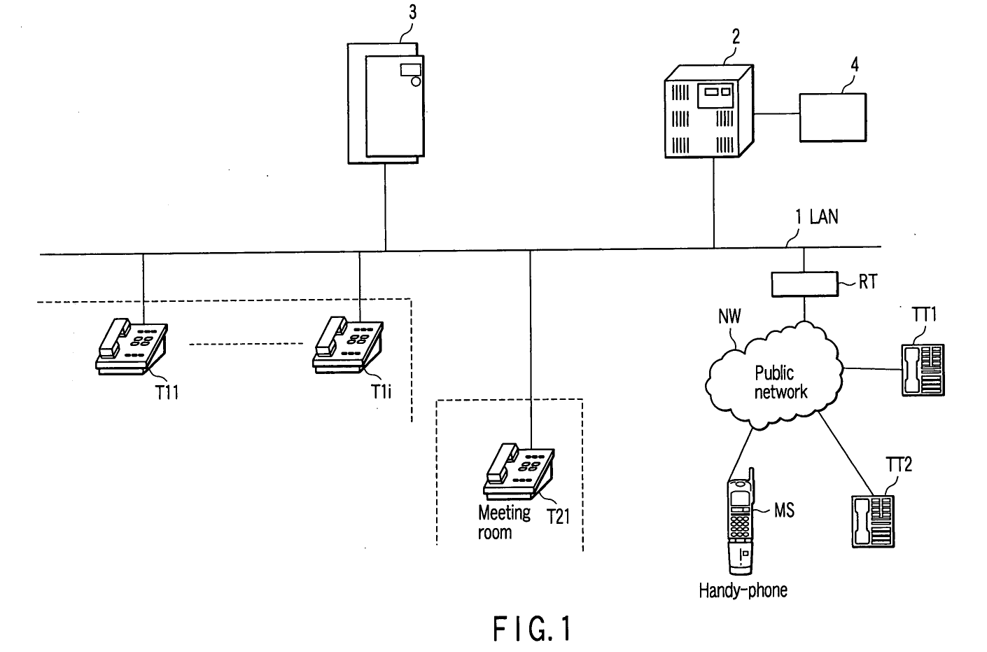

FIG. 1 schematically shows the configuration of an embodiment of a network telephone system according to the present invention.

This system has a LAN (Local Area Network) 1. A plurality of telephone terminals T11 to T1i (i is a natural number) and T21 are connected to the LAN 1. Further connected to the LAN 1 are a main unit 2, a server unit 3, and a router RT. The main unit 2 connects the telephone terminals T11 to T1i and T21 connected to the LAN 1 to one another and further connects the telephone terminals T11 to T1i and T21 to the router RT. The server unit 3 manages schedule information about the individual users of, for example, the telephone terminals T11 to T1i. The router RT, which connects the LAN 1 to the public network NW, has the function of converting the communication protocol and signal format between the LAN 1 and public network NW.

A voice mail unit 4 is connected to the main unit 2. The voice mail unit 4 records voice messages in sound and enables the recorded voice messages to be listened to at the respective telephone terminals T11 to T1i, T21 according to playback specify inputs.

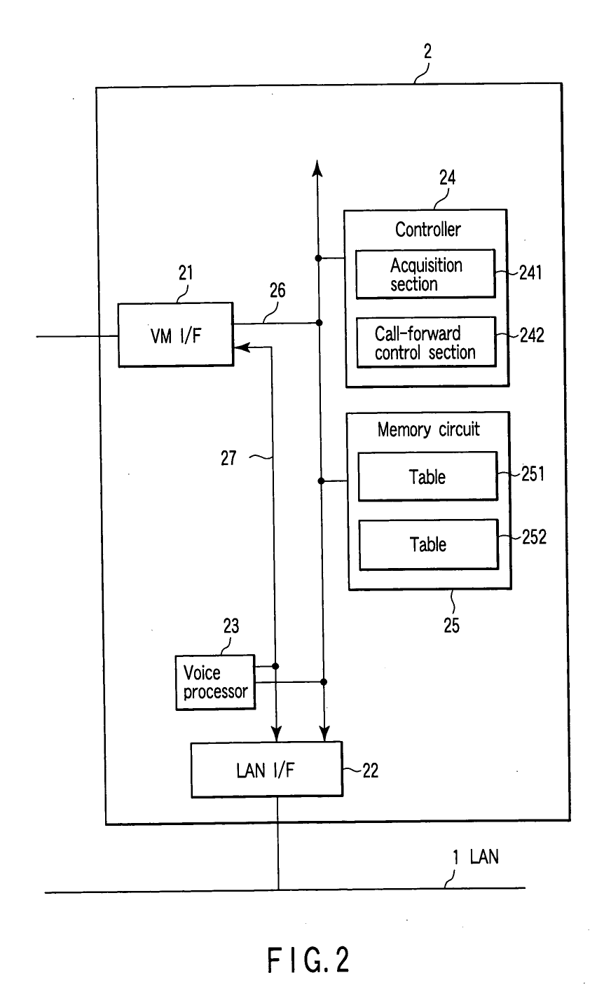

The main unit 2 has the following function related to the present invention. FIG. 2 is a block diagram showing the configuration of the main unit 2.

The main unit 2 comprises a voice mail interface (I/F) section 21 (hereinafter, referred to as VM I/F 21), a LAN interface (I/F) section 22 (hereinafter, referred to as LAN I/F 22), a voice processor 23, a controller 24, and a memory circuit 25. The VM I/F 21, LAN I/F 22, voice processor 23, controller 24, and memory circuit 25 are connected to one another via a data highway 26.

The VM I/F 21, LAN I/F 22, and voice processor 23 are connected to one another via a PCM highway 27.

The voice mail unit 4 is connected to the VM I/F 21 as needed. The VM I/F 21 provides an interface between the connected voice mail unit 4 and the PCM highway 27. In addition, the voice mail interface 21 exchanges various pieces of control information about the interfacing with the controller 24 via the data highway 26.

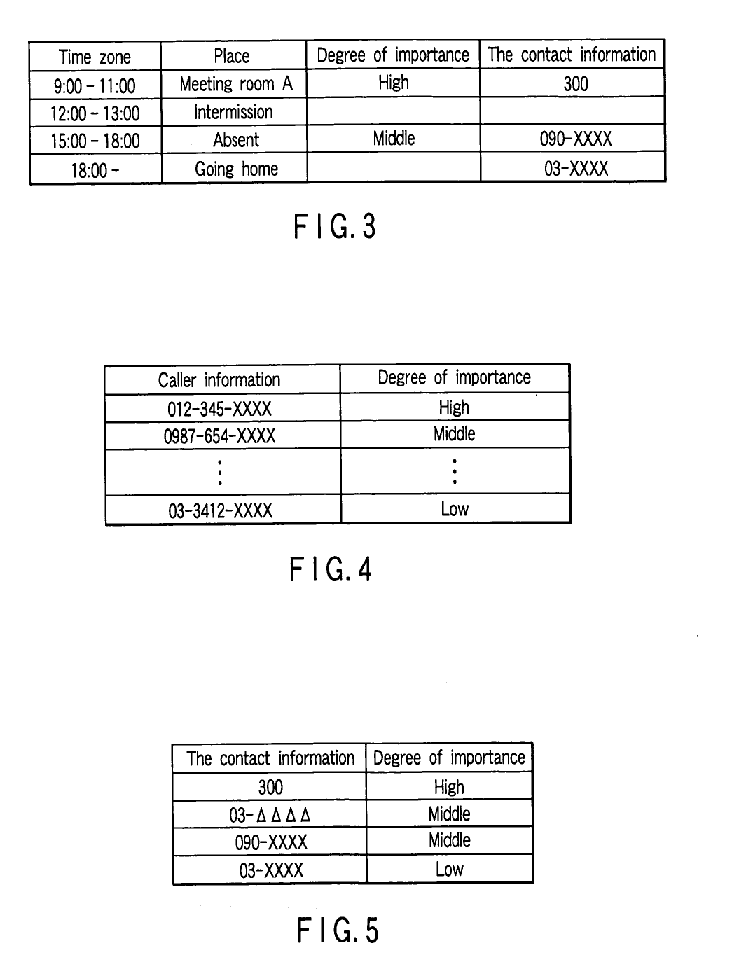

The LAN 1 is connected to the LAN I/F 22 as needed. The LAN I/F 22 provides an interface between the connected LAN 1 and the PCM highway 27. In addition, the LAN I/F 22 exchanges various pieces of control information related to the interfacing with the controller 24 via the data highway 26, and acquires the schedule information as shown in FIG. 3 from the server unit 3 via LAN 1.

The voice processor 23 has the function of converting the voice packets received from the LAN 1 into a voice signal that can be handled by the voice mail unit 4 and forwarding the voice signal to the voice mail unit 4.

The controller 24, which includes a CPU, a ROM, and a RAM, controls each section of the main unit 2 by software processing.

The memory circuit 25 stores not only routing information or the like necessary for connection control of the controller 24 but also a caller-to-degree-of-importance correspondence table 251 (hereinafter, referred to as table 251) and a forwarding-destination-to-degree-of-importance correspondence table 252 (hereinafter, referred to as table 252). For example, the table 251 stores, for example, the correspondence between information about callers and the degree of importance of each piece of information about callers as shown in FIG. 4.

The table 252 stores, for example, the correspondence between information about forwarding destinations and the degree of importance of each piece of the forwarding destination information as shown in FIG. 5.

The controller 24 includes a schedule information acquisition section 241 (hereinafter, referred to as acquisition section 241) and an incoming call forwarding control section 242.

The acquisition section 241 communicates with the server unit 3, thereby acquiring schedule information about the users of the telephone terminals T11 to T1i from the server unit 3. The schedule information includes, for example, the time zone, the places to which the user is to move in the time zone, the degree of importance of each of the places, and the telephone number of each of the places. The server unit 3 manages each user's schedule information for one week or one month, for example.

In a case where incoming call control of the telephone terminal T11 acting as an incoming call destination is impossible at the time of the generation of an incoming call, the incoming call forwarding control section 242 not only causes the acquisition section 241 to acquire schedule information about the user of the telephone terminal T11 from the server unit 3 and reads the degree-of-importance information corresponding to the notified caller information from the table 251 but also reads the degree-of-importance information corresponding to the relevant forwarding destination in the schedule information from the table 252 and compares the former degree-of-importance information with the latter. Then, if it has been determined from the result of the comparison that the forwarding of an incoming call has been permitted, the incoming call forwarding control section 242 provides incoming call control of the telephone terminal T21 serving as the forwarding destination.

Next, various operations of the system configured as described above will be explained.

(Incoming Call Forwarding Operation when the User is in a Meeting)

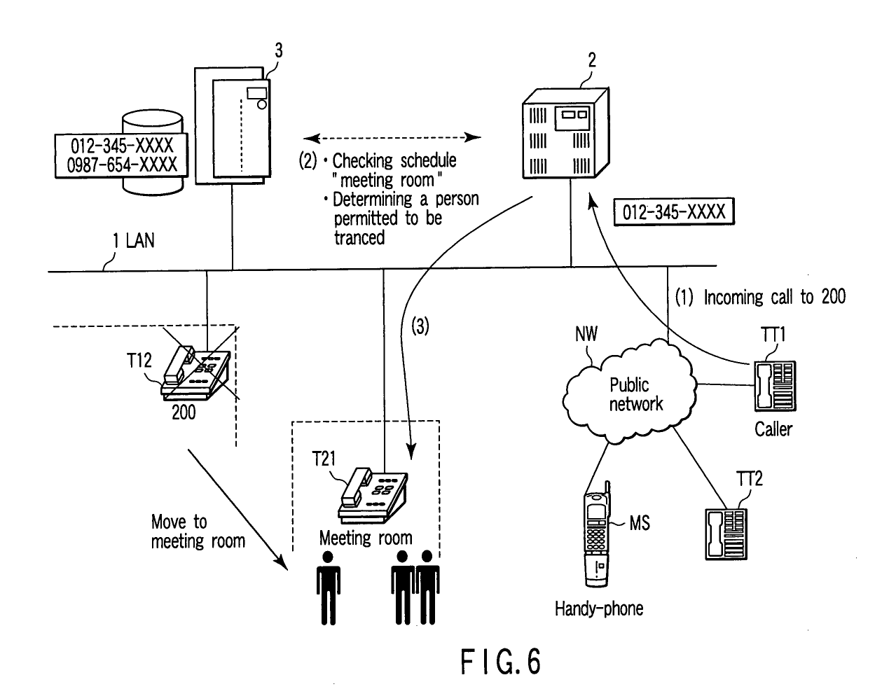

For example, it is assumed that an external telephone terminal TT1 originates a call designating a telephone terminal T12 (extension number 200) as the incoming call destination at about 9:00 and then a terminating call including the incoming call telephone number arrives at the router RT from the public network NW as shown in FIG. 6. In this case, the main unit 2 extracts the incoming call telephone number from the incoming call data notified by the router RT, determines an incoming call destination corresponding to the incoming call telephone number and the telephone terminal T12, and transmits the incoming call data to the telephone terminal T12 to cause the terminal T12 to inform the incoming call.

At this time, however, it is assumed that, because the user of the telephone terminal T12 at the incoming call destination has moved to the meeting room, no response was made to the incoming call during a specific period of time. Then, the main unit 2 acquires schedule information about the user of the telephone terminal T12 from the server unit 3 and determines whether an incoming call forwarding destination has been registered in the schedule information. Then, for example, if that the incoming call forwarding destination is the telephone terminal T21 in the meeting room has been registered, the main unit 2 not only read the degree-of-importance information “high” corresponding to caller information “012-345-xxxx” included in the incoming call data from the table 251 but also reads the degree-of-importance information “high” corresponding to the forwarding destination “300” from the table 252 and compares the former degree-of-importance information with the latter to determine whether the forwarding of the incoming call is permitted, or whether tracing is permitted.

If tracing is permitted, the main unit 2 transmits the incoming call data to the telephone terminal T21 acting as the incoming call forwarding destination and causes the telephone terminal T21 to notify the incoming call.

(Incoming Call Forwarding Operation when the User is Out)

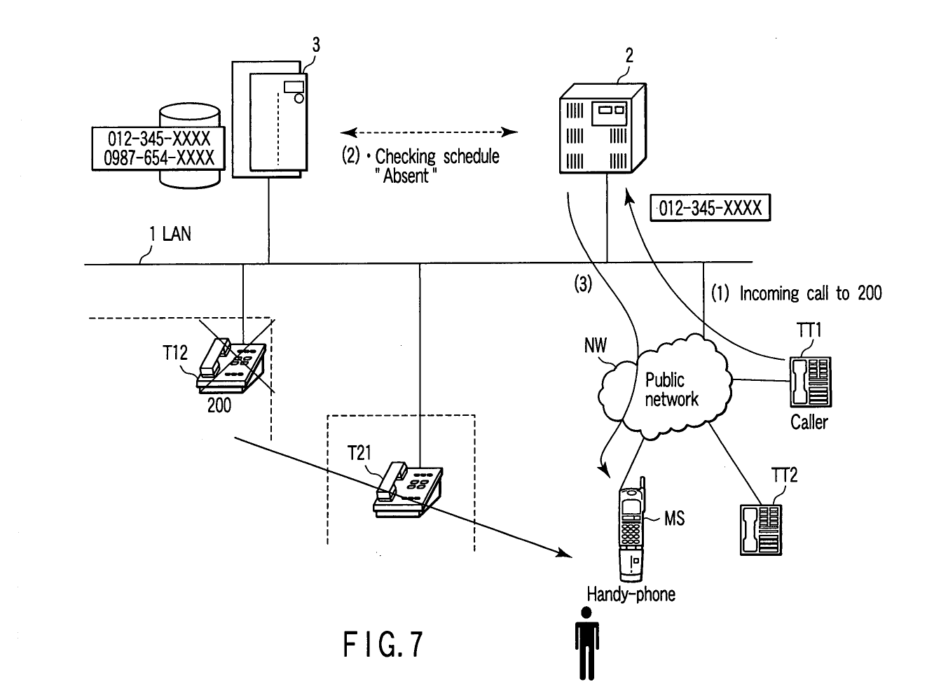

For example, it is assumed that the external telephone terminal TT1 originates a call designating the telephone terminal T12 (extension number 200) as the incoming call destination after 15:00 or later and then a terminating call including the incoming call telephone number arrives at the router RT from the public network NW as shown in FIG. 7. In this case, the main unit 2 extracts the incoming call telephone number from the incoming call data notified by the router RT, determines an incoming call destination corresponding to the incoming call telephone number and the telephone terminal T12, and transmits the incoming call data to the telephone terminal T12 to cause the terminal T12 to inform the incoming call.

At this time, however, it is assumed that, because the user of the telephone terminal T12 at the incoming call destination is out, no response was made to the incoming call during a specific period of time. Then, the main unit 2 acquires schedule information about the user of the telephone terminal T12 from the server unit 3 and determines whether an incoming call forwarding destination has been registered in the schedule information. Then, for example, if that the incoming call forwarding destination is a mobile phone MS has been registered, the main unit 2 not only reads the degree-of-importance information “high” corresponding to caller information “012-345-xxxx” included in the incoming call data from the caller-to-degree-of-importance correspondence table 251 but also reads the degree-of-importance information “middle” corresponding to the forwarding destination “090-xxxx” from the destination-to-degree-of-importance table 252 and compares the former degree-of-importance information with the latter to determine whether the forwarding of the incoming call is permitted, or whether tracing is permitted.

If tracing is permitted, the main unit 2 generates a forwarding request signal addressed to the public network NW and transmits the signal to the public network NW by way of the LAN 1 and router RT. The public network NW has a communication forwarding service function. When receiving the forwarding request signal, the public network NW actuates the communication forwarding function. Then, the public network NW calls up the mobile phone MS at the forwarding destination, while holding the communication link with the telephone terminal TT1. When the mobile phone MS makes a response, the public network NW connects the mobile phone MS to the telephone terminal TT1 and disconnects the communication link with the router RT.

When the mobile phone MS does not make an incoming call response in a specific period of time, the main unit 2 transmits the incoming call data to the voice mail unit 4 and causes the voice mail unit 4 to record the voice message.

(Processing of the Controller of the Main Unit in Forwarding an Incoming Call)

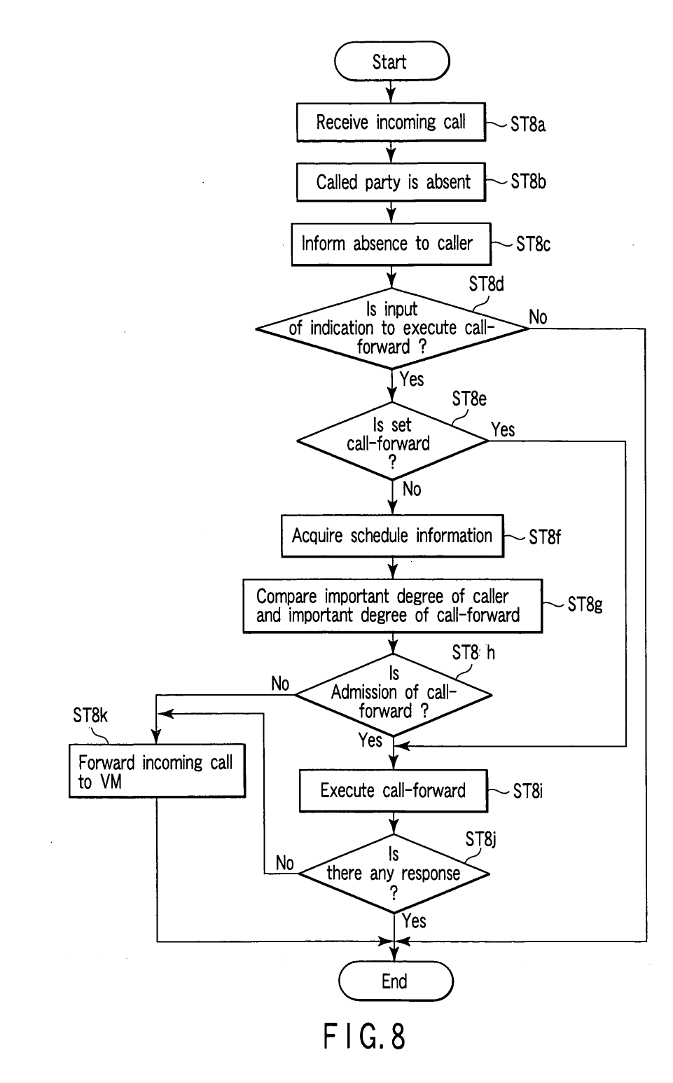

FIG. 8 is a flowchart to help explain the processing of the controller 24 in the main unit 2.

When a control process is started, the controller 24 monitors whether a terminating call arrives. If a terminating call has arrived (step ST8a), the controller 24 transmits the incoming call data to, for example, the telephone terminal T12 acting as an incoming call destination to cause the telephone terminal to inform the call incoming. If the user has made no response in a specific period of time because of absence (step ST8b), the controller 24 informs the user in sound of the message that the called party is absent or causes the display unit of the caller's telephone terminal to display the message (guidance display) (step ST8c). The user at the calling party determines whether to input an incoming call forwarding instruction (step ST8d). If the user at the calling party has put the phone on the hook or inputted no incoming call forwarding instruction within a specific period of time (No), the controller 24 ends the process without doing anything. If the user has inputted an incoming call forwarding instruction (Yes), the controller 24 determines whether an incoming call forwarding destination has been registered in the telephone terminal T12 acting as a forwarding destination (step ST8e).

Then, if an incoming call forwarding destination has not been registered (No), the controller 24 inquires schedule information on the user of the telephone terminal T12 at the incoming call destination from the server unit 3. If the schedule information is obtained at a result of the inquiry (step ST8f), the controller 24 reads not only the degree-of-importance information corresponding to the caller information notified by the calling party from the table 251 but also the degree-of-importance information corresponding to the forwarding destination in the schedule information from the table 252, compares the former degree-of-importance information with the latter (step ST8g), and determines whether the forwarding of the incoming call is permitted (step ST8h).

Here, for example, when the degree of importance of the calling party is “high” and the degree of importance of the forwarding destination is “high” or “middle” or “low” (Yes), the controller 24 transmits the incoming call data to, for example, the telephone terminal T21 acting as the forwarding destination and causes the telephone terminal to notify the incoming call (step ST8i). Then, the controller 24 determines whether an incoming call response is made in a specific period of time (step ST8j). If an incoming call response has been made (Yes), the controller 24 connects, for example, the telephone terminal TT1 at the calling party to the telephone terminal T21 at the forwarding destination and ends the process.

On the other hand, in step ST8h, if the forwarding of the incoming call is not permitted (No) as when, for example, the degree of importance of the calling party is “middle” or “low” and the degree of importance of the forwarding destination is “high,” or if the telephone terminal T21 at the forwarding destination have made no incoming call response within a specific period of time (No) in step ST8j, the controller 24 transmits the incoming call data to the voice mail unit 4, connects the telephone terminal TT1 at the calling party to voice mail unit 4, and causes the voice mail unit 4 to record the voice message from the calling party (step ST8k).

In step ST8e, for example, if the user has registered an incoming call destination in the telephone terminal T12 acting as an incoming call destination, or if the user has inputted an instruction to cause the telephone terminal T21 at the move destination to receive a terminating call addressed to the telephone terminal T12 (Yes), the controller 24 passes control to step ST8i.

In addition, if the user at the calling party has not inputted an incoming call forwarding instruction in step ST8d, the controller 24 ends the process.

In the above process, if the user at the calling party has requested the voice mail unit 4 to record a voice message in the guidance display in step ST8c, if no caller information has been notified in step ST8g, or if no forwarding destination has been registered in the schedule information, control is passed to step ST8k, where the voice message from the calling party is recorded in the voice mail unit 4.

As described above, in the embodiment, when a terminating call addressed to the telephone terminal T12 has arrived at the main unit 2 and the telephone terminal T12 cannot receive the call, the acquisition section 241 acquires schedule information about the user of the telephone terminal T12, that is, a forwarding destination information list for planned movements during a specific period of time, from the server unit 3. Then, the incoming call forwarding control section 242 reads not only the degree of importance corresponding to the caller information notified by the calling party from the table 251 but also the degree of importance corresponding to the forwarding destination in the schedule information and determines on the basis of the degrees of importance whether the forwarding of the incoming call has been permitted. If the forwarding of the incoming call has been permitted, the incoming call forwarding control section 242 causes the telephone terminal T21 acting as the forwarding destination to receive the terminating call.

Therefore, when a terminating call from a specific caller with a high degree of importance has arrived at the telephone terminal T12, while the user of the telephone terminal T12 is in conference in a meeting room, the terminating call can be forwarded to and received by the telephone terminal T21 installed in the meeting room. When a terminating call from a caller with a low degree of importance has arrived at the telephone terminal T12, the terminating call can be forwarded to the voice mail unit 4. As a result, forwarding need not be set each time the user of the telephone terminal T12 moves. In a case where the forwarding destinations for planned moves are known beforehand, the forwarding destinations are registered in the schedule information and the degree of importance of each caller is registered beforehand. With these registrations, each caller is dealt with efficiently, which improves the user's convenience.

In the embodiment, the main unit 2 communicates with the server unit 3 which manages schedule information about each user, thereby acquiring the schedule information. As a result, a large number of pieces of forwarding destination information can be registered in the server unit 3 without providing a memory for storing the schedule information. This prevents the main unit 2 from becoming larger in configuration and therefore the manufacturing cost is suppressed.

Furthermore, in the embodiment, when a terminating call addressed to the telephone terminal T12 has arrived at the main unit 2 and the telephone terminal T12 cannot receive the call, the main unit 2 causes the telephone terminal TT1 at the calling party to display on its display unit the message that the calling party is absent. When receiving an instruction from the user at the calling party, the main unit 2 forwards the incoming call to the telephone terminal T21 at the forwarding destination. Therefore, the user at the calling party need not call up, when it is not necessary to call up the forwarding destination at the present time.

In addition, according to the embodiment, when the destination is changed suddenly from the user's seat to a meeting room, the user of the telephone terminal T12 inputs an instruction to receive a terminating call addressed to the telephone terminal T12 by means of the telephone terminal T21 at the meeting room to which the user is to move. By doing this, a terminating call addressed to the telephone terminal T12 can be forwarded to and received by the telephone terminal T21 without updating the schedule information. Similarly, when incoming call forwarding is set for the telephone terminal T21 by means of the telephone terminal T12, a terminating call addressed to the telephone terminal T12 can be forwarded to and received by the telephone terminal T21 without updating the schedule information.

Furthermore, according to the embodiment, when a terminating call from an indefinite caller or from a caller whose degree of importance is lower than that of the forwarding destination has arrived at the telephone terminal T12 and the telephone terminal T12 cannot receive the call, the terminating call is forwarded to the voice mail unit 4, thereby leaving the caller's message. In addition, when a definite move destination, such as an intermission, has not been registered, or when a forwarding destination has not been registered, the caller's message can be left by forwarding a terminating call addressed to, for example, the telephone terminal T12 to the voice mail unit 4.

Additionally, in the embodiment, when the telephone terminal is a mobile phone MS with an electronic mail transmission/reception function to receive a terminating call at the move destination, the telephone terminal can transmit information on the arrival of a terminating call at the telephone terminal T12 and the caller information in electronic mail form according to the select instruction set by the user. Therefore, when the user of the telephone terminal T12 cannot answer the telephone at the move destination, information on the arrival of an incoming call at the telephone terminal T12 and the caller information are transmitted in electronic mail form to the mobile phone MS, which enables the user to call back on the basis of the caller information written in the received electronic mail, at the time when the user can answer the telephone. This is not limited to the mobile phone MS. For instance, the same holds true for telephone terminal T14 with an electronic mail transmission/reception function.

In the embodiment, when a terminating call addressed to the telephone terminal T12 has arrived and incoming call control of the telephone terminal T12 is impossible, only the message that the called party is absent can be notified to the user at the calling party according to the selective instruction given by the user of the telephone terminal T12 (in greeting display). Therefore, when the user of the telephone terminal T12 is absent for a long time, only the message that the called party is absent can be notified to the user at the calling party. This feature is very effective in taking measures against nuisance calls.

The present invention is not limited to the above embodiment. In the embodiment, the caller-to-degree-of-importance correspondence table and the forwarding-destination-to-degree-of-importance correspondence table have been stored in the memory circuit of the main unit. This invention is not restricted to this. For instance, only the caller-to-degree-of-importance correspondence table may be stored in the memory circuit. In this case, for example, even when terminating calls from callers whose degree of importance is high, such as customers, and terminating calls from callers whose degree of importance is low concentrate in the same time zone, the terminating calls from callers whose degree of importance is high are forwarded preferentially to the telephone terminals at the forwarding destinations and the terminating calls from callers whose degree of importance is low are forwarded to the voice mail unit. Therefore, even if terminating calls from a plurality of callers concentrate in the same time zone, they can be handled with relative flexibility.

In the embodiment, the main unit has communicated with the server unit, thereby acquiring the schedule information. The present invention is not restricted to this. For instance, when the schedule information has been stored in the disk set in the main unit, the schedule information may be read from the disk.

Furthermore, in the embodiment, the degrees of importance stored in the forwarding-destination-to-degree-of-importance correspondence table have been used. When the degree of importance corresponding to the forwarding destination is included in the schedule information, the degree of importance may be used.

In addition, this invention has been applied to a network telephone system where each telephone terminal is connected to the main unit via a LAN. The invention is not limited to this. For instance, the invention may be applied to a private branch exchange system where each telephone terminal is connected to the main unit via an extension. In this case, the main unit has to incorporate an interface for connecting with the server unit.

As for the type and configuration of the main unit, the type of the telephone terminals, the controlling procedure of the main unit in forwarding an incoming call and its contents, the contents of the degree of importance, the contents of the schedule information, and the like, this invention may be practiced or embodied in still other ways without departing from the spirit or essential character thereof.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

1. A telephone exchange apparatus which connects a plurality of telephone terminals and is adapted to connect to at least one network and which is adapted to forward a call arriving at one telephone terminal to another, the telephone exchange apparatus comprising:
an acquisition circuit configured to selectively acquires schedule information that includes destination information showing the destinations of the users of at least a part of the plurality of telephone terminals for a specific period of time, and forwarding destination information showing a first telephone terminal to receive an incoming call at each of the destinations;
a memory circuit configured to store degree-of-importance information showing the degree of importance of call forwarding in such a manner that the degree-of-importance information corresponds to caller information showing a telephone terminal at the calling party; and
a controller which controls the acquisition circuit to acquire the schedule information about the user of a second telephone terminal acting as an incoming call destination, and performs incoming call control of the first telephone terminal based on the schedule information and the degree-of-importance information corresponding to the caller information, when incoming call control of the second telephone terminal is impossible.

2. The telephone exchange apparatus according to claim 1, further comprising an interface which connects to a server apparatus which manages the schedule information,
wherein the acquisition circuits acquires the schedule information by communicating with the server apparatus via the interface.

3. The telephone exchange apparatus according to claim 1, further comprising another memory circuit which stores degree-of-importance information showing the degree of importance of an incoming call in such a manner that the degree-of-importance information corresponds to the forwarding destination information,
wherein the controller compares the degree-of-importance information corresponding to the caller information with the degree-of-importance information corresponding to the forwarding destination information, and performs incoming call control of the first telephone terminal based on the result of the comparison, when incoming call control of the second telephone terminal is impossible.

4. The telephone exchange apparatus according to claim 1, wherein the controller forwards the terminating call to a third telephone terminal differing from the first telephone terminal, when a terminating call addressed to the second telephone terminal has arrived, and an instruction to receive a terminating call addressed to the second telephone terminal is given from the third telephone terminal.

5. The telephone exchange apparatus according to claim 1, wherein the controller forwards the terminating call to a third telephone terminal differing from the first telephone terminal, when a terminating call addressed to the second telephone terminal has arrived, and incoming call forwarding is set in the third telephone terminal.

6. The telephone exchange apparatus according to claim 1, wherein the controller performs incoming call control based on the schedule information and the degree-of-importance information corresponding to the caller information, when incoming call control of the second telephone terminal is impossible, informs the user at the calling party that the called party is absent and prompts the user to input an instruction to call up the first telephone terminal, and the user at the calling party has inputted a call-up instruction in response to the prompt.

7. The telephone exchange apparatus according to claim 1, further comprising an interface which connects with a voice mail apparatus adapted to record the voice of the user at the calling party in the form a voice message,
wherein the controller performs incoming call control of the voice mail apparatus acting as a forwarding destination under preset conditions via the interface, when a terminating call addressed to the second telephone terminal has arrived, and incoming call control of the second telephone terminal is impossible.

8. The telephone exchange apparatus according to claim 7, wherein the controller performs incoming call control of the voice mail apparatus according to any one of the preset conditions that caller information is different from the caller information stored in the memory circuit, that the degree of importance corresponding to the caller information is the lowest, that forwarding destination information is not included in the schedule information, and that the user at the calling party inputs a call-up instruction to the voice mail apparatus.

9. The telephone exchange apparatus according to claim 1, wherein the first telephone terminal communicates an electronic mail,
the controller transmits information that an incoming call has arrived at the second telephone terminal and the caller information in electronic mail form to the first telephone terminal according to a selective instruction given by the user of the second telephone terminal, when a terminating call addressed to the second telephone terminal has arrived and incoming call control of the second telephone terminal is impossible.

10. The telephone exchange apparatus according to claim 1, wherein the controller informs the user at the calling party only that the called party is absent, according to a selective instruction given by the user of the second telephone terminal, when a terminating call addressed to the second telephone terminal has arrived and incoming call control of the second telephone terminal is impossible.

11. The telephone exchange apparatus according to claim 1, wherein the first telephone terminal is at least one of a telephone terminal connected to the network and a mobile phone terminal,
the controller forwards the terminating call to at least one of the telephone terminal connected to the network and mobile telephone terminal, when a terminating call addressed to the second telephone terminal has arrived and incoming call control of the second telephone terminal is impossible.

12. A telephone exchange system which includes a plurality of telephone terminals connected to a communication network, and an exchange apparatus which houses said plurality of telephone terminals via the communication network and connects said plurality of telephone terminals to cause the telephone terminals to communicate with one another,
the exchange apparatus comprising:
an acquisition circuit configured to selectively acquire schedule information that includes destination information showing the destinations of the users of at least a part of the plurality of telephone terminals for a specific period of time and forwarding destination information showing a first telephone terminal to receive an incoming call at each of the destinations;
a store circuit configured to store degree-of-importance information showing the degree of importance of call forwarding in such a manner that the degree-of-importance information corresponds to caller information showing a telephone terminal at the calling party; and
a controller which controls the acquisition circuit to acquire the schedule information about the user of a second telephone terminal acting as an incoming call destination, and performs incoming call control of the first telephone terminal based on the schedule information and the degree-of-importance information corresponding to the caller information, when incoming call control of the second telephone terminal is impossible.
